(19) United States
(12) Patent Application Publication
(10) Pub. No.: US 2023/0013163 A1
(43) Pub. Date: Jan. 19, 2023

(54) CROSS BRACE AND MODULAR FURNITURE

(71) Applicant: VITRA AG, Birsfelden (CH)

(72) Inventors: Stefan KELLER, Steinen - Hofen (DE); Helmut SCHÜTT, Mülllheim - Hügelheim (DE)

(21) Appl. No.: 17/779,629

(22) PCT Filed: Nov. 25, 2020
(86) PCT No.: PCT/EP2020/083376

§ 371 Date: May 25, 2022

(30) Foreign Application Priority Data
Nov. 25, 2019 (CH) 01485/19

(51) Int. Cl. A47B 47/02; F16B 7/04

(52) U.S. Cl. CPC A47B 47/028; F16B 7/048; A47B 47/027

(57) ABSTRACT

The invention relates to a cross brace (4) comprising an elongate bar portion (41) and two clips (42). The bar portion (41) has two substantially opposite longitudinal ends. The two clips (42) are each arranged on one of the two longitudinal ends of the bar portion (41) and are designed to almost fully enclose a bar-shaped element (22, 52). Furthermore, the two clips (42) can each be brought into an opened position, in which the bar-shaped element (22, 52) can be received by the clip (42) and removed from the clip (42), and into a closed position, in which the bar-shaped element (22, 52) can be fully enclosed by the clip (42). The clips (42) have a lock (425) which locks the clip (42) in the closed position.

### TECHNICAL FIELD

The invention relates to a cross brace and to a furniture kit. Such a furniture kit can be used to flexibly assemble, disassemble, and rebuild furniture.

### BACKGROUND

Systems for flexibly assembling furniture, in which furniture can be variably constructed from basic parts, are known. Variable modular furniture systems are particularly common in shops or offices, where the furniture or the requirements for the furniture typically change from time to time.

Known variable modular furniture systems are often based on a three-dimensional supporting tube structure that can be assembled in different ways. For example, EP 0 262 090 A1 describes a furniture structure which has a plurality of tubes that can be connected via node elements. In this system, the tubes can be joined in different ways by means of the node elements and, in particular, frames of different shapes can be created. The connected tubes can also be equipped with screens and shelves which are mounted between the tubes.

In modern office environments, for example, there is an increasing need to frequently completely alter the furniture. Despite their variability, known modular furniture systems are disadvantageous because they have to be dismantled and reassembled in a complex manner. This is typically carried out by trained personnel using special tools. This is necessary partly for safety reasons, since the modular furniture system must guarantee that the resulting furniture is sufficiently stable. Unstable furniture can pose a significant risk to people, especially in the case of relatively high and/or heavily loaded furniture.

Since, as mentioned above, assembling, rebuilding, and disassembling furniture using the known modular furniture systems is complex and can pose a safety risk if done improperly, people now often refrain from adapting furniture to changing needs. For example, in open office environments, in which it might make sense to adapt the furniture on a project-by-project basis, no use is made of the variability of modular furniture systems.

The object of the following invention is therefore to propose a system or parts for a system with which stable and safe furniture can be created and converted flexibly, easily, and virtually without tools.

### SUMMARY OF EMBODIMENTS OF THE INVENTION

The object is achieved according to the invention by a cross brace and by a furniture kit as described herein. Advantageous embodiments of the invention can be found in the various descriptions provided herein of embodiments hereof

The essence of the invention is as follows: A cross brace comprises an elongate bar portion and two clips. The bar portion has two substantially opposite longitudinal ends. The two clips are each arranged at one of the two longitudinal ends of the bar portion. Furthermore, the two clips are designed to almost fully enclose a bar-shaped element. In addition, the two clips can each be brought into an opened position, in which the bar-shaped element can be received by the clip and removed from the clip, and into a closed position, in which the bar-shaped element can be fully enclosed by the clip. In addition, the two clips each have a lock that locks the clip in the closed position.

The cross brace can be provided to be installed in a piece of furniture and to stabilize it. In particular in the case of furniture based on a three-dimensional tube structure, such as a frame, the cross brace can ensure appropriate stability, so that the furniture can absorb sufficient loads and can be set up securely when in use. Furthermore, the cross brace can also be used in other tube structures, in particular three-dimensional ones, such as scaffolding for stabilization.

The term “furniture” in the context of the invention refers to furnishings primarily in interior spaces such as homes, shops, offices, or other functional units. Furniture is typically moveable, in contrast to immovable objects (property) that are rigidly connected to the ground or to structures. In most cases, furniture has a predetermined purpose and is intended for a specific use. Typical furniture can be tables, chairs, shelves, racks, and the like.

The bar portion can be a tube- or beam-like structure. It can be tubular with a hollow interior or, in particular, can be solid. Solid bar portions can be particularly robust and load-bearing.

The bar-shaped element can be a component or a portion of a component. For example, it can be a tube of a scaffolding structure. In particular, it can be a rung of a piece of furniture that is to be stabilized with the cross brace.

By equipping the cross brace with the clips, the rungs or the bar-shaped element can be enclosed and held rigidly or securely. This means that bar-shaped elements or rungs can be held rigidly by the cross brace even when the cross brace is oriented obliquely. Twisting of the two components, which comprise bar-shaped elements, relative to one another can be reliably prevented in this way. Correspondingly, the cross brace can give a structure such as a three-dimensional tube structure sufficient stability so that it is suitable for absorbing a relatively large load or other forces. The safety of the three-dimensional tube construction or of a piece of furniture can also be increased or guaranteed in this way. At the same time, the clips of the cross brace also enable it to be put together and taken apart in an efficient manner. This means that a piece of furniture or another three-dimensional tube construction can be efficiently assembled, rebuilt, and disassembled with the help of the cross brace.

For safety reasons, the clips can be designed in such a way that they can only be opened with a key or a simple tool such as a screwdriver. This can prevent the clips from being opened inadvertently.

The two clips are preferably designed in the manner of handcuffs. They preferably each comprise a first enclosing portion, which is designed to partially enclose the bar-shaped element, and a second enclosing portion, which is designed to partially enclose the bar-shaped element. The first enclosing portion and the second enclosing portion of each of the two clips are designed to fully enclose the bar-shaped element together.

The first enclosing portion and the second enclosing portion of each of the two clips are preferably designed to enclose the bar-shaped element approximately halfway. Together, the enclosing portions can then fully enclose the bar-shaped element and hold it securely.

The first enclosing portion and the second enclosing portion of each of the two clips are preferably pivotably interconnected or rotatably interconnected. Enclosing portions connected in this way can be moved relative to each other in an efficient manner so that they can be easily opened and closed.

The two clips preferably each have a hinge about which the first enclosing portion and the second enclosing portion can be pivoted relative to one another. Such a hinge enables a stable pivotable connection with one degree of freedom in a comparatively simple construction.

The first enclosing portion and the second enclosing portion of each of the two clips are preferably designed in such a way that together they abut the bar-shaped element at three contact points when the clip fully encloses the bar-shaped element. The three contact points enable the bar-shaped element to be held efficiently and precisely. In addition, the bar-shaped element can be prevented from tilting relative to the clip.

The three contact points of the first and second enclosing portions are preferably arranged so as to be semi-regularly spaced apart on the first enclosing portion and on the second enclosing portion. Thus, the bar-shaped element can be securely held in an efficient manner.

Preferably, the two clips each have a connecting portion that fixedly transitions into the bar portion. The fixed transition can be implemented by forming the bar portion and the connecting portions so as to be integral. In order to achieve efficient manufacture of the cross brace, the fixed transition can be implemented by rigidly connecting the connecting portions of the clips to the longitudinal ends of the bar portion. For example, they can be welded, screwed, glued, or similarly connected.

The connecting portions of the clips are preferably each formed integrally with the first enclosing portion. In this way, a stable and robust clip can be efficiently manufactured.

The locks of the clips preferably each comprise a bolt and a spring element, the bolt being movable between a locked position and an unlocked position and the spring element pushing the bolt into the locked position. Such a locking mechanism enables a secured clip to be realized efficiently. The bolt can, for example, be fastened or mounted on the connecting portion such that it can rotate or move like a pendulum.

In this case, the second enclosing portions of the clips are preferably each formed with a latching lug which engages behind the bolt when the clip is in the closed position. In this way, the clip can be securely locked using a form fit.

The locks of the clips preferably each have an unlocking mechanism via which the bolt can be moved into the unlocked position counter to the spring force. The unlocking mechanism can be designed in such a way that it can only be actuated with the aid of a tool such as a key or a screwdriver. In this way, safety can be improved and unintentional opening of the clip can be avoided.

Another aspect of the invention relates to a furniture kit. The furniture kit includes a set of floor ladders, a set of elongate traverses, and a cross brace, as described above. The floor ladders each comprise two vertical supports which are connected to one another via an upper rung and a lower rung, the two vertical supports each being equipped with a foot for setting them upright on a floor. The traverses are each equipped at their longitudinal ends with a snap-in claw which is designed to be mounted on one of the rungs of one of the floor ladders without tools. The clips of the cross brace are each designed in such a way that one of the rungs of the floor ladders or one of the traverses is the bar-shaped element.

The furniture kit can be provided so that different pieces of furniture can be flexibly assembled from the same components as required. Such a piece of furniture can be, for example, shelves, frames, or tables. In particular, the furniture can be office furniture.

The term “set”, in connection with the furniture kit and its floor ladders, traverses, and cross braces, refers to a plurality of elements or components. For example, the set of floor ladders includes two or more floor ladders.

In addition to the upper and lower rungs, the floor ladders can also include other rungs. Typically, the vertical supports and the rungs are substantially bar-shaped. The rungs in particular, but also the vertical supports, can have a substantially round or circular cross-section. The vertical supports and the rungs of a floor ladder can each be more or less at right angles to one another, so that the rungs run parallel to one another and the vertical supports parallel to one another.

The vertical supports of the floor ladders can be designed over large distances as bar profiles or, for example, round or square tubes. They are typically made from a sturdy material such as metal. The vertical supports of a floor ladder advantageously run parallel to one another.

The rungs of the floor ladders can also be designed over large distances as bar profiles or tubes. Advantageously, they have a circumference with a more or less circular cross-section. In use, the upper and lower rungs are advantageously aligned horizontally and run parallel to one another.

The feet of the floor ladders can be designed as sliders, for example. If the furniture created from the furniture kit is intended to be moved frequently, rollers can also be used as the feet of the floor ladders.

Advantageously, the traverses are elongate so that they extend between two rungs of the same height of the first of the floor ladders and of the second of the floor ladders when they are mounted thereon. At the same time, the cross brace can be designed so that it can be mounted on the upper rung of the first of the floor ladders and the lower rung of the second of the floor ladders, while one of the traverses is mounted on the upper rung of the first of the floor ladders and on the upper rung of the second of the floor ladders. As a result, the cross brace can be connected to the floor ladders at an angle or diagonally, while the traverses are connected horizontally to the floor ladders.

Alternatively, the cross brace can also be connected horizontally to the rungs of the floor ladders or other rungs. This can be done in particular when corresponding dimensioning is desired in the piece of furniture.

The effects and advantages explained above in connection with the cross brace according to the invention can be efficiently implemented with the furniture kit according to the invention.

### BRIEF DESCRIPTION OF THE DRAWINGS

Further advantageous designs of the invention can be found in the following description of embodiments of the invention with the aid of the schematic drawings. In particular, the cross brace according to the invention and the furniture kit according to the invention are described in more detail below with reference to the accompanying drawings using embodiments.

FIG. 1 is a front view of a floor ladder of an embodiment of a furniture kit according to the invention.

FIG. 2 is a front view of a structural ladder of the furniture kit of FIG. 1.

FIG. 3 is a view from above of a traverse of the furniture kit of FIG. 1.

FIG. 4 is a side view of a snap-in claw of the traverse of FIG. 3.

FIG. 5 is a front view of an embodiment of a cross brace according to the invention of the furniture kit of FIG. 1.

FIG. 6 is a view from above of the cross brace of FIG. 5.

FIG. 7 is a perspective view of a clip of the cross brace of FIG. 5 in an opened position.

FIG. 8 is a perspective view of the clip of FIG. 7 in a closed position.

FIG. 9 is a perspective view of the clip of FIG. 7 in the opened position showing an interior of the clip.

FIG. 10 is a perspective view of the clip of FIG. 9 during a transition from the opened position to the closed position.

FIG. 11 is a perspective view of the clip of FIG. 9 in the closed position.

FIG. 12 is a perspective view of a frame construction assembled from the furniture kit of FIG. 1.

### DETAILED DESCRIPTION OF EMBODIMENTS OF THE INVENTION

Certain terms are used in the following description for practical reasons and are not intended to be limiting. The words “right,” “left,” “below”, and “above” indicate directions in the drawing to which reference is made. The terms “inward,” “outward” “below,” “above,” “left,” “right”, or similar are used to describe the arrangement of designated parts relative to each other, the movement of designated parts relative to each other, and the directions toward or away from the geometric center of the invention and designated parts thereof as shown in the drawings. This relative spatial information also includes different positions and orientations than those shown in the drawings. For example, if a part shown in the drawings is turned over, elements or features that are described as “below” are then “above.” The terminology includes the words expressly mentioned above, derivatives of same, and words of similar meaning.

In order to avoid repetitions in the drawings and the associated description of the different aspects and embodiments, certain features should be understood as common to different aspects and embodiments. The omission of an aspect from the description or a drawing does not suggest that this aspect is missing from the associated embodiment. Rather, such omission may be for the purpose of clarity and preventing repetitions. In this context, the following statement applies to the rest of the description: If reference signs are included in a drawing for the sake of clarifying the drawing, but are not mentioned in the directly associated description text, reference is made to their explanation in the preceding description of the drawings. Furthermore, if reference signs are mentioned in the description text belonging directly to a drawing, but are not contained in the associated drawing, reference is made to the preceding and following drawings. Similar reference signs in two or more drawings denote similar or identical elements.

FIG. 1 shows a floor ladder 2 of a set of floor ladders 2 of an embodiment of a furniture kit 1 according to the invention. The floor ladder 2 is designed as the first component of an embodiment of a tube connection structure according to the invention. It consists of two parallel vertical supports 21 which are connected to one another by two horizontal rungs 22. The rungs 22 are designed as straight tubes with a circular cross-section. They are at right angles to the vertical supports 21 and are rigidly connected to them, for example welded. The vertical supports 21 are also designed mostly as straight tubes with a circular cross-section and each transition into a tapering foot 23 at the bottom. The two feet 23 are each equipped with a slider 24 which is arranged on the floor for setting the floor ladder 2 upright.

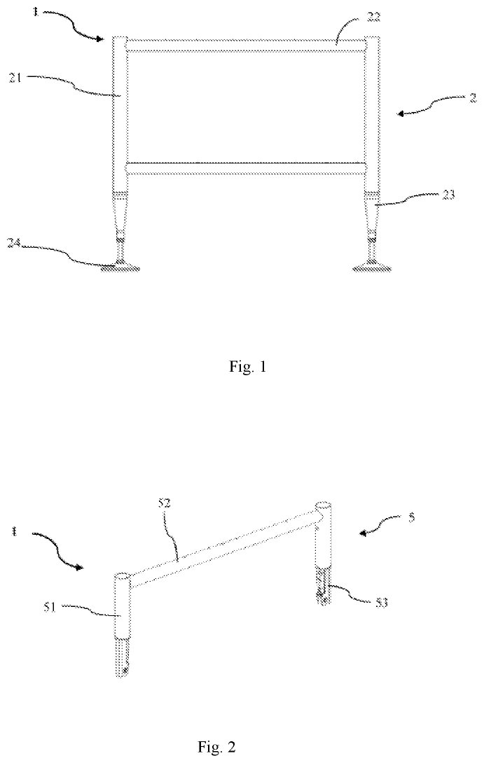

In FIG. 2, a one-rung structural ladder 5 of a set of structural ladders 5 of the furniture kit 1 is shown. The structural ladder 5 is designed as a second component of an embodiment of a tube connection structure according to the invention. It comprises two tubular vertical supports 51 which are rigidly connected to one another via a tubular rung 52. Together, the vertical supports 51 and the rung 52 are more or less U-shaped. The rungs 52 of the structural ladder are dimensioned identically to the rungs 22 of the floor ladder 2 of FIG. 1, so that the structural ladder 5 matches the floor ladder 2.

A tube connector 7 of the tube connection structure extends vertically downward from the lower ends of the vertical supports 51 of the structural ladder 5. The tube connectors 7 are designed in such a way that they can be inserted into the vertical supports 21 of the floor ladder 2 or into vertical supports 51 of a further structural ladder 5 and fixed to one another by actuating the connected vertical supports 21, 51.

In addition to the structural ladder 5, as shown in FIG. 2, the set of structural ladders 5 of the furniture kit 1 includes further structural ladders with vertical supports connected via two parallel rungs. In comparison with the one-rung embodiment of FIG. 2, these structural ladders are designed to be longer or taller.

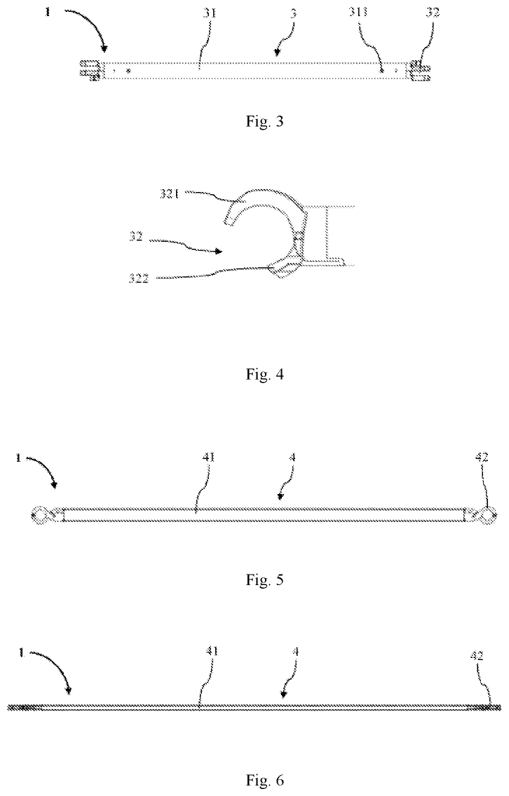

FIG. 3 shows a traverse 3 of a set of traverses 3 of the furniture kit 1. The traverse 3 is formed by an elongate bar portion 31 and snap-in claws 32 extending outward from the longitudinal ends of the bar portion 31 on the left and right. The bar portion 31 is formed by a tube with a circular diameter corresponding to the diameter of the rungs 52 of the structural ladder 5 and the rungs 22 of the floor ladder 2. The bar portion 31 is equipped on the top thereof with a bore 311 as a female plug part close to its longitudinal ends. The snap-in claws 32 each comprise a rung receptacle 321 as an enclosing portion.

The bar portion 31 of the traverse 3 has a central longitudinal axis 33 which extends through the center point of the circular cross-section of the bar portion 31. As can be seen in FIG. 3, the rung receptacle 321 of the left snap-in claw 32 is offset with respect to the central longitudinal axis 33 of the bar portion 31 to the rung receptacle 321 of the right snap-in claw 32. In particular, in FIG. 3 the rung receptacle 321 of the left snap-in claw 32 is offset upward with respect to the central longitudinal axis 33 and the rung receptacle 321 of the right snap-in claw 32 is offset downward with respect to the central longitudinal axis 33.

In FIG. 4, the left of the two snap-in claws 32 of the traverse 3 of FIG. 3 is shown enlarged by way of example. It can be seen that the snap-in claw 32 has an upper rung receptacle 321 formed integrally with a base and a lower slide 322. The rung receptacle 321 has an almost semi-circular or semi-annular inner surface, which has a shape substantially corresponding to the rungs 22, 52 of the floor ladders and structural ladders 2, 5. Similarly, the slide 322 is equipped with an approximately quarter-circular or quarter-ring-shaped inner surface, which also has a shape substantially corresponding to the rungs 22, 52 of the floor ladders and structural ladders 2, 5. On the inner surfaces of the rung receptacle 321 and the slide 322, three contact bulges are distributed evenly along the circumference.

The slider 322 extends through a guide slot of the base so that it can be slid to the left and right of the base by a predefined extent. Inside the base, the snap-in claw 32 is equipped with a spring that pushes the slider 322 to the maximum leftward position shown in FIG. 4. In this locking position, the snap-in claw 32 is snapped onto a rung 22, 52 or a bar portion 31 of another traverse 3 when the rung receptacle 321 and the slide 322 receive said rung or bar portion. The traverse 3 is then mounted on the rung 22, 52 or the bar portion 31. In particular, the rung 22, 52 abuts the three contact bulges in the sense of a three-point connection, so that the rung 22, 52 or the bar portion 31 is held securely and tilting can be prevented.

To release the snap-in claw 32, the slide 322 is pushed to the right, for example manually, counter to the spring force. As a result, the snap-in claw 32 is opened and the traverse 3 can be removed from the rung 22, 52 upward.

To mount the traverse 3 on a rung 22, 52 or on a bar portion 31 of another traverse 3, the snap-in claw 32 is pushed onto the rung 22, 52 or the bar portion 31 from above. The slanted or angled underside of the slide 322 pushes it to the right counter to the spring force, so that the rung receptacle 321 can hold the rung 22, 52 or the bar portion 31. Driven by the spring, the slide 322 then catches again below the rung 22, 52 or the bar portion 31, so that a secure fastening is achieved.

FIG. 5 shows an embodiment of a cross brace 4 according to the invention of a set of cross braces 4 of the furniture kit 1. The cross brace 4 has a bar portion 41 which transitions into a clip 42 at each of its longitudinal ends. As can be seen in conjunction with FIG. 6, the bar portion 41 is designed as a solid square bar with a rectangular cross-section. Due to the solid design, the cross brace 4 can be particularly robust and designed to absorb comparatively large forces or loads.

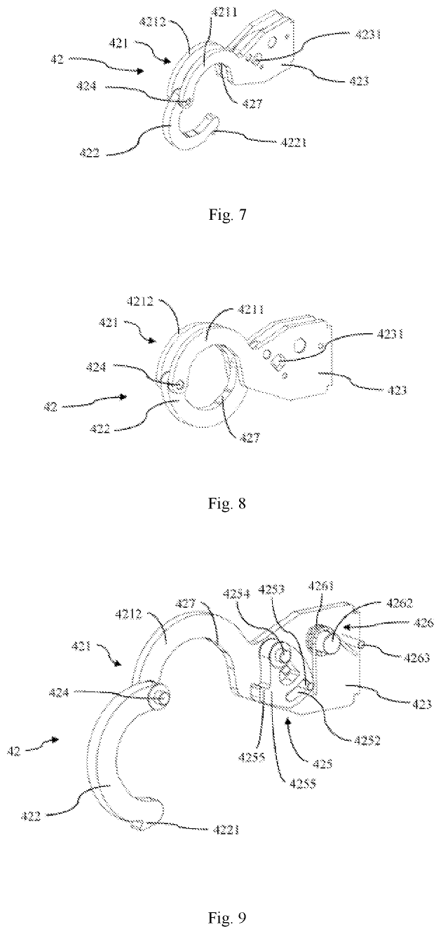

FIG. 7 shows an example of a left-hand clip of the clips 42 of the cross brace 4 in an opened position. The clip 42 is provided with a base 423, an upper enclosing portion 421, and a lower enclosing portion 422, like a handcuff The base 423 is fixedly connected to the bar portion 41. The base consists of two identical plate elements, which transition into a first half-ring finger 4211 and a second half-ring finger 4212 of the upper enclosing portion 421. In particular, the first and second half-ring fingers 4211, 4212 are formed integrally with the two plate elements of the base 423, respectively.

The lower enclosing portion 422 is pivotably mounted to the upper enclosing portion 421 via a hinge joint 424. In particular, a tangential end of the lower enclosing portion 422 is arranged between the first and the second half-ring fingers 4211, 4212. The hinge joint 424 is formed by a joint pin extending through openings in the two half-ring fingers 4211, 4212 and the lower enclosing portion 422. It has a single degree of freedom, namely rotation about the axis of the joint pin.

At its tangential end facing away from the half-ring fingers 4211, 4212, the lower enclosing portion 422 is equipped with a latching lug 4221 extending radially outward. Furthermore, the plate elements of the base 423 each have an unlocking opening 4231 of an unlocking mechanism, through which a lock as described below is accessible by means of a screwdriver.

In FIG. 8 the clip is shown in a closed position. The lower enclosing portion 422 is moved upward to be locked to the base 423 as described below. As a result, the upper enclosing portion 421 and the lower enclosing portion 422 together form a circular or annular passage in which the bar-shaped element or one of the rungs 22, 52 of the floor ladder or structural ladders 2, 5 can be arranged. Along the inner circumference, the upper and lower enclosing portions 421, 422 have three regularly distributed contact bulges 427 as contact points. If one of the rungs 22, 52 is arranged in the passage, it abuts the contact bulges 427 on the enclosing portions 421, 422. As a result, the rung 22, 52 is held securely in the clip 42 in the sense of a three-point connection.

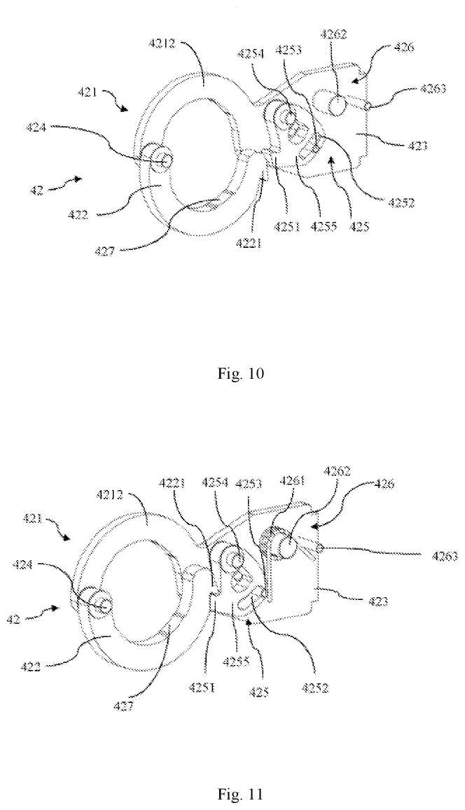

FIG. 9 shows the clip 42 in the opened position without the first half-ring finger 4211 and the associated plate element of the base 423, so that a region between the two plate elements of the base 423 is visible. In particular, a lock 425 and associated spring mechanism 426 can be seen. The lock 425 comprises a pendulum element 4255 as a bolt, which is equipped on its left side with a lug 4251 extending radially to the left. At its upper end, the pendulum element 4255 is rotatably mounted via a pendulum pin 4254 which is fixedly connected to the plate elements. The pendulum element 4255 is also equipped with a guide slot 4252 running along its lower edge, through which a stop pin 4253 fixedly connected to the plate elements extends. In this case, the guide slot 4255 and the stop pin 4253 define the extent of a rotational movement of the pendulum element 4255 about the pendulum pin 4254 between a locked position and an unlocked position.

The spring mechanism 426 comprises a helical torsion spring 4261 with two projecting legs. A spring pin 4262 which is fixedly connected to the base 423 extends through the windings of the torsion spring 4261. The torsion spring 4261 is rotatable about the spring pin 4262. The right of the two legs of the torsion spring 4261 abuts a spring stop 4263 which is fixedly connected to the base 423. The left of the two legs of the torsion spring 4261 abuts a right edge of the pendulum element 4255. In this way, the torsion spring 4261 is clamped between the spring stop 4263 and the pendulum element 4255 and pushes the pendulum element 4255 clockwise about the pendulum pin 4254 until the stop pin 4253 strikes the right-hand end of the guide slot 4252. As a result, the lug 4251 of the pendulum element 4255 is moved to the left to the maximum extent and the pendulum element 4255 is in the locked position.

As shown schematically in FIG. 10, when the clip 42 is closed, the lower enclosing portion 422 is rotated counterclockwise about the hinge joint 424 until the latching lug 4221 pushes against the lug 4251 and the pendulum element 4255 is thereby pushed counter to the spring force of the torsion spring 4261 (not shown in FIG. 10) to the right into the unlocked position.

If the lower enclosing portion 422, as shown in FIG. 11, is rotated far enough about the hinge joint 424 that the latching lug 4221 is above the lug 4251 of the pendulum element 4255, the torsion spring 4261 pushes the oscillating element 4255 to the left and the latching lug 4221 engages behind the lug 4251. In this closed position, the latching lug 4221 and the lug 4251 create a form fit, so that the lock 425 locks the clip 42. In this locked or closed position, one of the rungs 22, 52 can be held securely in the clip 42 and loosening of the clip 42 without actuation of the lock 425 can be avoided.

To unlock the clip 42, a screwdriver is inserted through the unlocking opening 4231 and the screwdriver pushes the pendulum element 4255 counter to the spring force to the right or counterclockwise about the pendulum pin 4254, as shown in FIG. 10. The lower enclosing portion 422 can now be rotated freely in a clockwise direction about the hinge joint 424 and the clip 42 can thereby be opened.

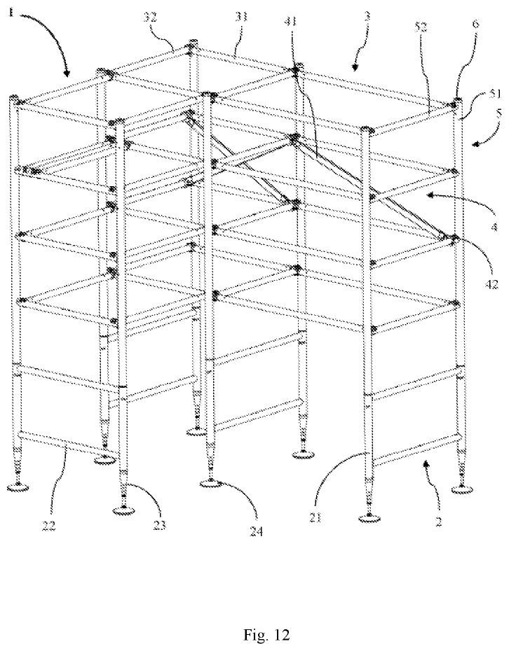

In FIG. 12, a frame construction assembled from the furniture kit 1 is shown as a three-dimensional supporting tube structure. The frame construction comprises four ladders, which are each formed by a floor ladder 2 and two structural ladders 5, each with two rungs 52, placed vertically thereon. The rungs 52 of the structural ladders 5, which are at the same height, are each connected to one another via two traverses 3. For this purpose, the snap-in claws 32 of the traverses 3 are mounted on the rungs 52 adjacent to the vertical supports 51 of the structural ladders 5. At the same time, a plurality of cross braces 4 are connected diagonally or obliquely with rungs 52 at two different heights.

By providing the traverses 3 together with the cross braces 4 on the ladders 2, 5, the frame construction is made extremely robust and rigid. In particular, it can absorb comparatively large loads in this way. The upper ends of the tube portions 51 of the uppermost structural ladders 5 are covered with covers 6 and closed.

Although the invention is depicted and described in detail by means of the drawings and the associated description, this depiction and detailed description should be understood as illustrative and exemplary and not as limiting to the invention. In order not to distort the invention, in some cases well-known structures and techniques cannot be shown and described in detail. It is understood that a person skilled in the art can make changes and modifications without departing from the scope of the following claims. In particular, the present invention covers further embodiments with any combination of features that may differ from the combinations of features explicitly described. For example, the invention can also be implemented or used in the following form:
The cross braces can also be used to horizontally connect floor ladders or structural ladders. They can replace the traverses and serve, for example, to support other components.
The furniture kit can be implemented without traverses, with the cross braces taking over the function of the traverses. For example, the furniture kit can include cross braces of different lengths.

The present disclosure also includes embodiments including any combination of features mentioned or shown above or below for various embodiments. It also includes individual features in the drawings, even if they are shown in connection with other features and/or are not mentioned above or below. The alternatives of embodiments and individual alternatives of their features that are described in the drawings and the description can be excluded from the subject matter of the invention or from the disclosed subject matter. The disclosure includes embodiments that only include the features described in the claims or in the embodiments and those that include other additional features.

Furthermore, the term “comprise” and derivatives thereof do not exclude other elements or steps. Likewise, the indefinite article “a” or “an” and derivatives thereof do not exclude a plurality. The functions of a plurality of features listed in the claims can be performed by one unit or one step. The terms “substantially,” “about,” “approximately” and the like in connection with a property or a value in particular also define the property or the value exactly. The terms “about” and “approximately” in connection with a given numerical value or range can refer to a value or range which lies within 20%, within 10%, within 5%, or within 2% of the given value or range.

1. A cross brace comprising:
an elongate bar portion and two clips, wherein the bar portion has two substantially opposite longitudinal ends, and the two clips
are each arranged at one of the two longitudinal ends of the bar portion,
are each designed to quasi fully enclose a bar-shaped element,
can each be brought into an opened position, in which the bar-shaped element can be received by the clip and removed from the clip, and into a closed position, in which the bar-shaped element can be fully enclosed by the clip, and
each have a lock which locks the clip in the closed position.

2. A cross brace of claim 1, wherein the two clips each comprise
a first enclosing portion which is designed to partially enclose the bar-shaped element, and
a second enclosing portion which is designed to partially enclose the bar-shaped element,
wherein the first enclosing portion and the second enclosing portion of each of the two clips are designed to fully enclose the bar-shaped element together.

3. A cross brace of claim 2, wherein the first enclosing portion and the second enclosing portion of each of the two clips are each designed to enclose the bar-shaped element approximately halfway.

4. The cross brace of claim 2, wherein the first enclosing portion and the second enclosing portion of each of the two clips are pivotably interconnected.

5. The cross brace of claim 4, wherein each of the two clips has a hinge about which the first enclosing portion and the second enclosing portion can be pivoted relative to one another.

6. The cross brace of claim 2, wherein the first enclosing portion and the second enclosing portion of each of the two clips are designed in such a way that together they abut the bar-shaped element at three contact points when the clip fully encloses the bar-shaped element.

7. The cross brace of claim 6, wherein the three contact points of the first and second enclosing portions are arranged so as to be semi-regularly spaced apart on the first enclosing portion and on the second enclosing portion.

8. The cross brace of claim 1, wherein the two clips each have a connecting portion which fixedly transitions into the bar portion.

9. The cross brace of claim 8, wherein the connecting portions of the clips are each formed integrally with the first enclosing portion.

10. The cross brace of claim 1, wherein the locks of the clips each comprise a bolt and a spring element, wherein the bolt is movable between a locked position and an unlocked position and the spring element pushes the bolt into the locking position.

11. The cross brace of claim 10, wherein the second enclosing portions of the clips each have a latching lug which engages behind the bolt when the clip is in the closed position.

12. The cross brace of claim 10, wherein the locks of the clips each have an unlocking mechanism via which the bolt can be moved into the unlocked position counter to the spring force.

13. The cross brace of claim 1, wherein the clips are designed in the manner of handcuffs.

14. A furniture kit, comprising:
a set of floor ladders, each of which comprises two vertical supports which are interconnected via an upper rung and a lower rung, wherein the two vertical supports are each equipped with a foot for setting them upright on a floor;
a set of elongate traverses, each of which is equipped at its longitudinal end with a snap-in claw designed to be mounted on one of the rungs of one of the floor ladders without tools; and
a cross brace of claim 1, wherein the clips of the cross brace are each designed in such a way that one of the rungs of the floor ladders or one of the traverses is the bar-shaped element.
